(19) United States
(12) Patent Application Publication
(10) Pub. No.: US 2026/0103197 A1
(43) Pub. Date: Apr. 16, 2026

(54) VEHICLE ROUTE LANE OPTIMIZATION

(71) Applicant: GM GLOBAL TECHNOLOGY OPERATIONS LLC, Detroit, MI (US)

(72) Inventors: Manoj Kumar SHARMA, Troy, MI (US); Akilesh RAJAVENKATANARAYANAN, Clinton Township, MI (US); Shu CHEN, Rochester Hills, MI (US); Donald K. GRIMM, Utica, MI (US)

(21) Appl. No.: 18/912,028

(22) Filed: Oct. 10, 2024

(51) Int. Cl. B60W 30/18; B60W 50/14; B60W 60/00

(52) U.S. Cl. CPC B60W 30/18163; B60W 50/14; B60W 60/001; B60W 2050/146; B60W 2555/20

(57) ABSTRACT

A vehicle system includes a control module and a display module. The control module is configured to identify a lane that the vehicle should be in to provide a smooth navigation based on a current driving route for the vehicle, changes to the current driving route, and real-time traffic conditions, determine a lane merge feasibility based on an expected headway value and a time gap to merge into the identified lane, determine a modified lane merge feasibility based on the lane merge feasibility and lane speed data; and identify a portion of the identified lane to merge based on the modified lane merge feasibility. The display module is configured to output a visual representation of the identified portion highlighted to indicate recommendations of which lane the vehicle should be in and where to merge into that lane. Other example vehicle systems and vehicle control methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle route lane optimization, and more particularly to vehicle systems and methods for providing vehicle route lane recommendations for a vehicle approaching an interchange based in part on telemetry crowdsourced data.

Vehicles often include navigation systems for vehicle tracking and providing instructions about upcoming maneuvers to reach desired locations. In such examples, the instructions may be provided to drivers of the vehicles or used for vehicle control in autonomous driving applications in the vehicles. In some scenarios, the navigation systems may rely on crowdsourced data from other vehicles to generate the instructions.

### SUMMARY

A vehicle system for providing vehicle lane recommendations for a vehicle traveling on a road, includes a control module and a display module in communication with the control module. The control module is configured to identify a lane that the vehicle should be in to provide a smooth navigation based on a current driving route for the vehicle, changes to the current driving route, and real-time traffic conditions, determine a lane merge feasibility based on an expected headway value and a time gap to merge into the identified lane, determine a modified lane merge feasibility based on the lane merge feasibility and lane speed data; and identify a portion of the identified lane to merge based on the modified lane merge feasibility. The display module is configured to output a visual representation of the identified portion highlighted to indicate recommendations of which lane the vehicle should be in and where to merge into that lane.

In other features, the vehicle system further includes a vehicle control module in communication with the control module. The vehicle control module is configured to control at least one operation of the vehicle based on the identified portion of the identified lane.

In other features, the control module is configured to modify the time gap to merge into the identified lane based on a cognitive status of a driver of the vehicle.

In other features, the control module is configured to modify the time gap to merge into the identified lane based on a condition of the road.

In other features, the vehicle lane recommendations for the vehicle are for a bifurcation of the road in which the road splits into two or more separate roads.

In other features, the lane speed data includes an average lane speed before the bifurcation and an average lane speed after the bifurcation.

In other features, the control module is configured to determine the modified lane merge feasibility based on the lane merge feasibility, the average lane speed before the bifurcation, and the average lane speed after the bifurcation.

In other features, the control module is configured to determine one or more reliability scores for each road segment of a plurality of road segments of the road based on a frequency of which each vehicle of a plurality of vehicles has traveled on the road, wherein each reliability score for each road segment is specific to a different driving condition, and select a road segment of the road segments with the highest reliability score having the driving condition that corresponds to a current driving condition associated with the vehicle.

In other features, the identified portion is a portion of the selected road segment to merge into the identified lane based on the modified lane merge feasibility.

In other features, the control module is configured to determine familiarity scores for the plurality of vehicles in each road segment based on the frequency of which the plurality of vehicles have traveled through the bifurcation, and determine the one or more reliability scores for each road segment based on the familiarity scores for that road segment.

In other features, the driving condition includes at least one of a different time of day, a different road condition, and a different weather condition.

In other features, the control module is configured to modify the one or more reliability scores for each road segment based on a frequency of braking incidents for the plurality of vehicles in the road segments of the road.

A vehicle system for providing vehicle lane recommendations for a vehicle traveling on a road, includes a control module and a vehicle control module in communication with the control module. The control module is configured to identify a lane that the vehicle should be in to provide a smooth navigation based on a current driving route for the vehicle, changes to the current driving route, and real-time traffic conditions, determine a lane merge feasibility based on an expected headway value and a time gap to merge into the identified lane, determine a modified lane merge feasibility based on the lane merge feasibility and lane speed data, and identify a portion of the identified lane to merge based on the modified lane merge feasibility. The vehicle control module configured to control the vehicle to merge in the identified portion.

In other features, the control module is configured to modify the time gap to merge into the identified lane based on a cognitive status of a driver of the vehicle.

In other features, the control module is configured to modify the time gap to merge into the identified lane based on a condition of the road.

In other features, the vehicle lane recommendations for the vehicle are for a bifurcation of the road in which the road splits into two or more separate roads.

In other features, the lane speed data includes an average lane speed before the bifurcation and an average lane speed after the bifurcation.

In other features, the control module is configured to determine the modified lane merge feasibility based on the lane merge feasibility, the average lane speed before the bifurcation, and the average lane speed after the bifurcation.

In other features, the control module is configured to determine one or more reliability scores for each road segment of a plurality of road segments of the road based on a frequency of which each vehicle of a plurality of vehicles has traveled on the road, wherein each reliability score for each road segment is specific to a different driving condition, and select a road segment of the road segments with the highest reliability score having the driving condition that corresponds to a current driving condition associated with the vehicle.

In other features, the identified portion is a portion of the selected road segment to merge into the identified lane based on the modified lane merge feasibility.

In other features, the control module is configured to determine familiarity scores for the plurality of vehicles in each road segment based on the frequency of which the plurality of vehicles have traveled through the bifurcation, and determine the one or more reliability scores for each road segment based on the familiarity scores for that road segment.

In other features, the driving condition includes at least one of a different time of day, a different road condition, and a different weather condition.

In other features, the control module is configured to modify the one or more reliability scores for each road segment based on a frequency of braking incidents for the plurality of vehicles in the road segments of the road.

A vehicle control method for providing vehicle lane recommendations for a vehicle traveling on a road, includes identifying a lane that the vehicle should be in to provide a smooth navigation based on a current driving route for the vehicle, changes to the current driving route, and real-time traffic conditions, determining a lane merge feasibility based on an expected headway value and a time gap to merge into the identified lane, determining a modified lane merge feasibility based on the lane merge feasibility and lane speed data, identifying a portion of the identified lane to merge based on the modified lane merge feasibility, and outputting a visual representation of the identified portion highlighted to indicate recommendations of which lane the vehicle should be in and where to merge into that lane.

In other features, the vehicle control method further includes controlling the vehicle to merge in the identified portion.

In other features, modifying the time gap to merge into the identified lane based on at least one of a cognitive status of a driver of the vehicle and a condition of the road.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example vehicle system for providing vehicle merge lane recommendations for a vehicle approaching an interchange, according to the present disclosure;

FIG. 2 is a map showing a multi-lane road bifurcating into two separate roads, with road segments identified by the vehicle system of FIG. 1 for changing lanes before the bifurcation, according to the present disclosure;

FIG. 3 is a visual representation of the multi-lane road bifurcating into two separate roads of FIG. 2, with a selected road segment highlighted for driver viewing, according to the present disclosure;

FIG. 4 is a visual representation of a multi-lane road with two intersections and a selected road segment highlighted for driver viewing, according to the present disclosure;

FIGS. 5-6 are example visual representations including selected road segments with portions highlighted, according to the present disclosure;

FIGS. 7-8 are example visual representations including notifications instructing a driver to merge, according to the present disclosure;

FIG. 9 is a flowchart of an example control process for providing vehicle lane recommendations for a vehicle traveling on a road, according to the present disclosure;

FIG. 10 is a flowchart of an example control process for providing visual representations of vehicle lane recommendations, according to the present disclosure;

FIG. 11 is a flowchart of an example control process for controlling a vehicle to merge based on vehicle lane recommendations, according to the present disclosure;

FIG. 12 is a flowchart of an example control process for determining familiarity scores, according to the present disclosure; and

FIG. 13 is a flowchart of an example control process for determining reliability scores, according to the present disclosure.

In the drawings, reference numbers may be reused to identify similar and/or identical elements.

### DETAILED DESCRIPTION

Vehicles include navigation systems for providing instructions about upcoming maneuvers to reach desired locations. To provide such instructions, current navigation systems may rely on road level information (e.g. high-level maps) and crowdsourced data. Navigation through interchanges may be difficult for drivers. For example, highway navigation may create confusion for a driver, especially when a highway bifurcates into multiple sub-routes and the driver is unfamiliar with the route. This confusion can result in the driver choosing an undesirable or wrong lane to be in for the upcoming interchange. In turn, the driver may miss a desired exit and/or potentially cause a wreck by attempting an untimely maneuver into a more appropriate lane at a reduced or increased speed.

The vehicle systems and vehicle control methods according to the present disclosure provide solutions for enabling lane traffic awareness to support comfortable navigation and merging experiences. For example, using traffic lane statistics derived from crowdsourced vehicle telemetry, the vehicle systems and methods can provide vehicle lane recommendations for a vehicle traveling on a road to ensure the vehicle is positioned in an appropriate lane at an appropriate time (e.g., the “right lane at the right time”). Such lane recommendations may be incorporated into a map for a display in the vehicle and/or used for route planning in autonomous driving applications in the vehicle.

For example, a vehicle traveling along a road may encounter an interchange, such as a multi-lane highway that bifurcates into multiple sub-routes. In such examples, the multi-lane highway may divide into two paths: two left lanes may lead to highway AA and three right lanes may lead to freeway BB. To successfully navigate this interchange (or other interchanges), a driver of the vehicle may need to ensure he/she has sufficient time to arrive at a target lane and stay on-route. In this scenario, the determination of when/where to maneuver into the target lane may need to account for adjacent vehicle traffic that is moving towards a similar destination. As such, the vehicle systems and vehicle control methods herein can determine a lane change (or merge) feasibility based on an expected headway and then modify the lane change feasibility based on lane speed data, as further explained herein. In such examples, the vehicle systems and vehicle control methods enable a display to assist the driver in performing the required lane change and/or enable vehicle control to perform the required lane change with sufficient time to meet navigation goals.

In other examples, the vehicle lane recommendations for the vehicle may be for other approaching road events. For instance, the vehicle lane recommendations may be for another type of interchange, approaching traffic congestion, an approaching accident, road conditions, upcoming maneuvers in navigation instructions (e.g., be in the right most lane when there are a lot of right turns, etc. . . . ) etc.

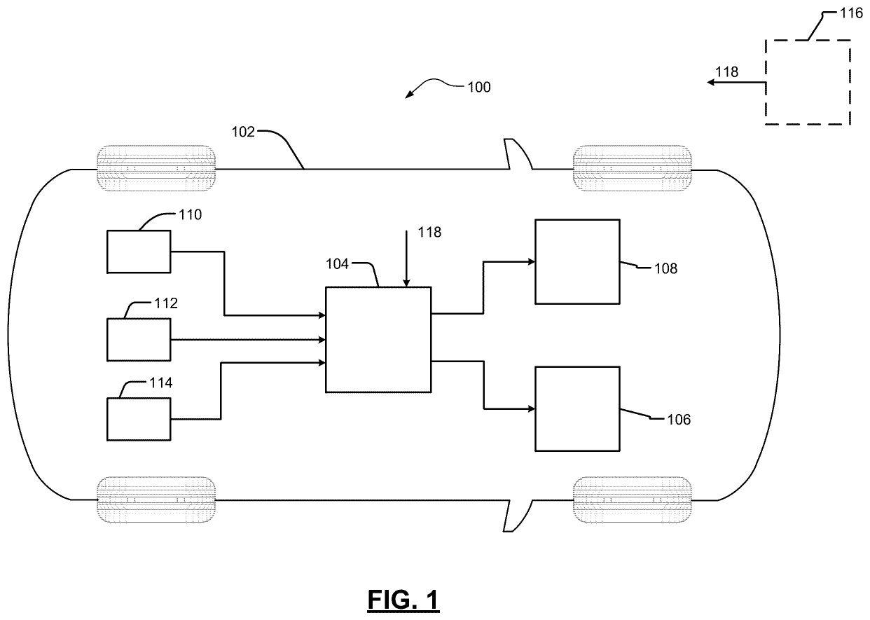

Referring now to FIG. 1, a block diagram of an example vehicle system 100 is shown for providing vehicle lane recommendations for a vehicle 102 traveling on a road. In FIG. 1, the vehicle system 100 generally includes a control module 104 internal to the vehicle 102, a display module 106, a vehicle control module 108 for controlling at least one operation of the vehicle 102, and multiple onboard sensors 110, 112, 114. Although FIG. 1 illustrates the vehicle system 100 as including specific dedicated modules, it should be appreciated that one or more other modules may be employed if desired. For example, any combination of the modules (e.g., the control module 104, the display module 106, the vehicle control module 108, etc.) and/or the functionality thereof may be integrated into a single module or multiple different modules. Additionally, although FIG. 1 illustrates three onboard sensors 110, 112, 114, it should be appreciated that any number of sensors can be arranged on the vehicle 102 if desired.

With continued reference to FIG. 1, the vehicle system 100 may be employable in any suitable vehicle, such as an autonomous vehicle, a semi-autonomous vehicle, etc. Additionally, the vehicle system 100 may be applicable to electric vehicles (e.g., a pure electric vehicle, a plug-in hybrid electric vehicle, etc.) and internal combustion engine (ICE) vehicles. In the example of FIG. 1, the vehicle system 100 is employed in the vehicle 102 (e.g., an autonomous vehicle).

In the example of FIG. 1, the onboard sensors 110, 112, 114, the display module 106, and the vehicle control module 108 are in communication with the control module 104. In such examples, the modules and sensors of the vehicle system 100 may share parameters via a network, such as a controller area network (CAN) and signals. For example, in FIG. 1, the control module 104 receives signals representing data from the sensors 110, 112, 114 and transmits signals to the display module 106 for displaying lane recommendations and the vehicle control module 108 for controlling vehicle operation.

In various embodiments, and as further explained herein, aspects of creating the vehicle lane recommendations may be implemented onboard the vehicle 102 itself and/or external to the vehicle 102. For example, the control module 104 may perform functions for creating spatial and temporal vehicle lane recommendations for upcoming road events (e.g., interchanges, congestion, accidents, etc.). In other examples, the vehicle system 100 may include an optional control module 116 external to the vehicle 102 and in communication with the control module 104 onboard the vehicle 102. In such examples, the control module 116 may perform some or all of the functions explained herein for creating spatial and temporal vehicle lane recommendations for the upcoming road events. For instance, and as further explained herein, the external (or remote) control module 116 may generally identify a lane that the vehicle 102 should be in to provide a smooth navigation (e.g., the “right lane at the right time”) and determine reliability scores for road segments (e.g., based on telemetry crowdsourced data) when such scores are desired and employable, and the control module 104 may generally determine a lane merge feasibility, modify the lane merge feasibility, and then identify a portion of the lane to merge. While the control functions for creating lane merging recommendations are explained below specific to both control modules 104, 116, it should be appreciated that either control module may separately implement the control functions itself.

In the example of FIG. 1, the control module 104 may receive one or more onboard inputs. For example, the onboard sensors 110, 112, 114 may detect one or more characteristics and provide one or more onboard inputs to the control module 104, such as vehicle acceleration, environmental data (e.g., characteristics of other vehicles, road conditions, weather conditions, etc.) external of the vehicle 102, driver characteristics (e.g., attentiveness of the driver, stress of the driver, drowsiness of the driver, etc.), etc. In such examples, the onboard sensors 110, 112, 114 may include, for example, external cameras (e.g., front camera modules, side camera modules, etc.), acceleration sensors, internal cameras (e.g., eye trackers, etc.), and/or any other suitable sensors. In some examples, the control module 104 may receive onboard inputs from automated driving systems, computer vision systems, etc. In various embodiments, some or all of the received onboard inputs from the onboard sensors 110, 112, 114 or otherwise may be transmitted to the control module 116.

Additionally, the control module 104 may receive one or more offboard inputs. Such offboard inputs may include, for example, data from one or more road databases, location data (e.g., from a global positioning system), and/or communications from vehicle-to-everything (V2X) systems, dedicated short range communications (DSRC) systems, cellular systems, etc. In such examples, some or all of the offboard inputs may be provided from the control module 116. More specifically, the some or all of the offboard inputs may be provided via one or more signals 118.

With continued reference to FIG. 1, the control module 116 receives crowdsourced data from vehicles, including possibly the vehicle 102, over a period of time that have traveled along the road. In such examples, the data may be telemetry data relating to, for example, vehicle characteristics. For instance, the crowdsourced data may include data relating to vehicle speeds, vehicle acceleration, vehicle deacceleration, location data, vehicle counts, frequency of travel, etc. In some examples, the location data may include, for example, latitudes, longitudes, headings, headways, and corresponding timestamps. In such examples, information may be ascertained from the crowdsourced data, such as a frequency (e.g., daily, weekly, etc.) of which a vehicle has traveled through a defined region of the road, a frequency or number of braking incidents for the vehicles in the defined region of the road, etc.

The control module 116 identifies a lane that the vehicle 102 should be in to provide a smooth navigation. In various embodiments, the control module 116 may identify this lane based on a current driving route for the vehicle, changes to the current driving route, and real-time traffic conditions. For example, the control module 116 may ascertain real-time traffic conditions based on the crowdsourced data from vehicles traveling along the road. Additionally, in some examples, the control module 116 may be provided (e.g., from the control module 104) the current driving route for the vehicle 102 and any possible changes to the driving route. In such examples, the navigation system may be employed to generate driving instructions for the current driving route and possible changes to the driving route.

Then, the control module 104 may determine a lane merge feasibility to merge into the identified lane. This lane merge feasibility determination may only take place if, for example, the vehicle 102 is not already in the identified lane. In such examples where the vehicle 102 is not already in the identified lane, the control module 104 may determine the lane merge feasibility based on a probability of having a time gap to merge into the identified lane.

In various embodiments, the control module 104 may determine the probability of having a time gap to merge and then the lane merge feasibility, according to equations (1)-(5) below. In such examples, the control module 104 may apply a probabilistic model to estimate a successful lane change probability, incorporating the assumption that a global positioning system (GPS) position, headway telemetry, host lane determination, and per-lane vehicle positions follow a Poisson point process of an expected headway. Here, the Poisson point process represents randomly located points. Such data may be collected from a headway sample record, which includes a latitude, a longitude, a heading, a headway, and timestamp data. In such examples, a headway is a measure of a temporal space between two vehicles (e.g., the vehicle 102 and another vehicle). For instance, the headway may be the time that elapses between the arrival of a leading vehicle at a designated test point and the arrival of a following vehicle at the same designated test point. The headway may be generally expressed in seconds per vehicle.

For example, an expected headway (A) may be defined according to equation (1) below. Here, an average headway may be determined considering a headway sample (e.g., a designated headway H) from the crowdsourced telemetry data.

$$λ = a v g ( H ) \qquad Equation ( 1 )$$

Then, considering a virtual road segment (S₀) and the expected headway (A), a vehicle count (V) in that virtual road segment (S₀) may be determined according to equation (2). In such examples, the virtual road segment (S₀) may correspond to a length of identified lane and the expected headway (A) may be determined from equation (1) above.

$$V = {S}_{0} / λ \qquad Equation ( 2 )$$

Then, the control module 104 may determine a time to perform a safe lane change, according to equation (3) below. For example, assuming an upcoming vehicle moves at a speed (v) and a safe lane change requires a vehicle gap distance (d₀), a time (tₒ) to perform a safe lane change can be estimated with equation (3) below.

$${t}_{0} = {d}_{0} / v \qquad Equation ( 3 )$$

The control module 104 may then determine a probability of having a time gap to merge, according to equation (4) below. For example, in equation (4), the probability that a random time (t) is greater than the time (tₒ) to perform a safe lane change is computed based on the expected headway (λ) determined above.

$$P ( t > {t}_{0} ) = {e}^{- λ t} \qquad Equation ( 4 )$$

Because the vehicle 102 is switching from one lane to the identified lane, it may be desirable to consider a difference in vehicle speeds between the adjacent lanes. If the speed difference between the lanes is too large, a lane change is regarded as unsafe. In such examples, a defined speed difference threshold (Avo) between the adjacent lanes may be applied to modify the lane change probability (determined in equation (4) above) for a particular portion of the road. This modified probability is referred to as a lane merge (or change) feasibility (LMF) and is determined according to equation (5) below. In equation (5), μ represents a constant scaling factor, Av represents a speed difference between the adjacent lanes (e.g., an average speed difference of vehicles in the adjacent lanes), and f₀ represents a minimum value of a lane merge feasibility which is required to safely lane merge. In such examples, the constant scaling factor (μ) may be greater than 0 and less than or equal to 1 (e.g., 0<μ≤1). Additionally, as the value of the speed difference (Av) increases, the value of the constant scaling factor (μ) decreases.

$$L M F = μ P ( t > {t}_{0} ) - ( 1 - μ ) Δ v \geq {f}_{0} when Δ v \geq Δ {v}_{0} \qquad Equation ( 5 )$$

Then, the control module 104 may determine a modified lane merge feasibility based on lane speed data. In such examples, the lane speed data may include a lane speed of a location before the approaching road event (e.g., the interchange, the congestion, the approaching accident, etc.) and a lane speed at a location after the road event. For instance, and as further explained below, the approaching road events.

For example, the control module 104 may determine the modified lane merge feasibility according to equation (6) below, which takes into account an average lane speed before the approaching road event and after the approaching road event. Specifically, in equation (6), the modified lane merge feasibility (LMF_{Mod}) is determined by finding a difference between an average lane speed (v) of the road before the road event and an average lane speed (v_{new}) after the road event. For instance, if the road event is an interchange, such as a bifurcation of the road in which the road splits into two or more separate roads as further explained below, the average lane speed (v) may be the average lane speed before the bifurcation and the average lane speed (v_{new}) may be the average lane speed after the bifurcation.

Then, this speed difference is multiplied by a scaling factor (δ). The modified lane merge feasibility (LMF_{Mod}) is then obtained by subtracting the scaled speed difference from the original lane merge feasibility (LMF) obtained from equation (5) above.

$$L M {F}_{M o d} = L M F - δ ( v - {v}_{n e w} ) \qquad Equation ( 6 )$$

In various embodiments, it may be desirable to modify the lane change feasibility before altering the lane change feasibility according to equation (6) above. In such examples, this initial modification may be based on, for example, driver characteristics, road conditions, etc. For example, the control module 104 may modify the probability of having a time gap to change lanes based on a cognitive status of a driver of the vehicle 102, which in turn modifies the lane change feasibility. As examples only, the cognitive status of the driver may relate to the driver's age, stress level, attentiveness, etc. In such examples, the required vehicle gap distance (d₀) may be increased in proportion to the driver's cognitive status, which can be ascertained from their driving behavior, provided via user input, etc. For example, a modified required vehicle gap distance (dₘ) may be determined according to equation (7) below. In equation (7), do represents the original required vehicle gap distance and delta (δ) represents a scaling factor determined based on the intensity of the driver's cognitive status. In such examples, the scaling factor may be greater for older drivers, higher levels of stress, etc. This modified required vehicle gap distance (dₘ) may be used in place of the required vehicle gap distance (d₀) in equation (3) above, which in turn adjusts the time (tₒ) to perform a safe lane change, the lane change probability, and the lane change feasibility of equations (4)-(6) above.

$${d}_{m} = {d}_{0} + δ {d}_{0} \qquad Equation ( 7 )$$

Additionally, in some examples, the control module 104 may modify the probability of having a time gap to change lanes based on a condition of the road, which in turn also modifies the lane change feasibility. For example, the road condition may vary depending on the weather and/or other external factors. In such examples, a poor road condition (e.g., icy, snow covered, snow packed, slushy, wet, etc.) may require an increased required vehicle gap distance as compared to a generally good condition (e.g., dry, etc.). As such, the required vehicle gap distance (d₀) may be increased in proportion to the road condition, which may be ascertained from sensor input. In such examples, equation (7) may be employed to determine a modified required vehicle gap distance (dₘ), with the scaling factor (δ) representing a degree of the road condition. For instance, an icy road condition may have a larger scaling factor value than a wet road condition.

Also, in various embodiments, a speed (v) of an upcoming vehicle may be changed based on the road condition and/or the driver's cognitive status. For instance, and with respect to the road condition, a modified speed (vₘ) may be determined according to equation (8) below. In equation (8), v represents the original speed of an upcoming vehicle (from equation (3) above) and delta (δ) represents a scaling factor determined based on a degree of the road condition, as explained above. This modified speed (vₘ) may be used in place of the speed (v) in equation (3) above, which in turn adjusts the time (tₒ) to perform a safe lane change, the lane change probability, and the lane change feasibility of equations (4)-(6) above.

$${v}_{m} = v - δ v \qquad Equation ( 8 )$$

Then, once the modified lane change feasibility is known, the control module 104 can identify the portion of the lane most optimal for merging. For example, the most optimal portion for merging may be the portion of the lane with the highest lane change feasibility.

In some examples, the control module 116 may identify an optimal point to make a lane change based on reliability scores associated with the crowdsourced data. In such examples, the control module 116 may utilize reliability scores when locations are fixed, such as known road bifurcations or other suitable types of interchanges.

For instance, when locations are fixed, the control module 116 may optionally identify road segments along the road for merging from one lane to another lane based on the crowdsourced data. For example, the control module 116 may utilize portions (e.g., location data, vehicle counts, etc.) of the crowdsourced data specific to a defined region of the road to identify the road segments most used by the vehicles (providing the crowdsourced data) to merge into another lane. In such examples, the defined region may be an area of interest of the road.

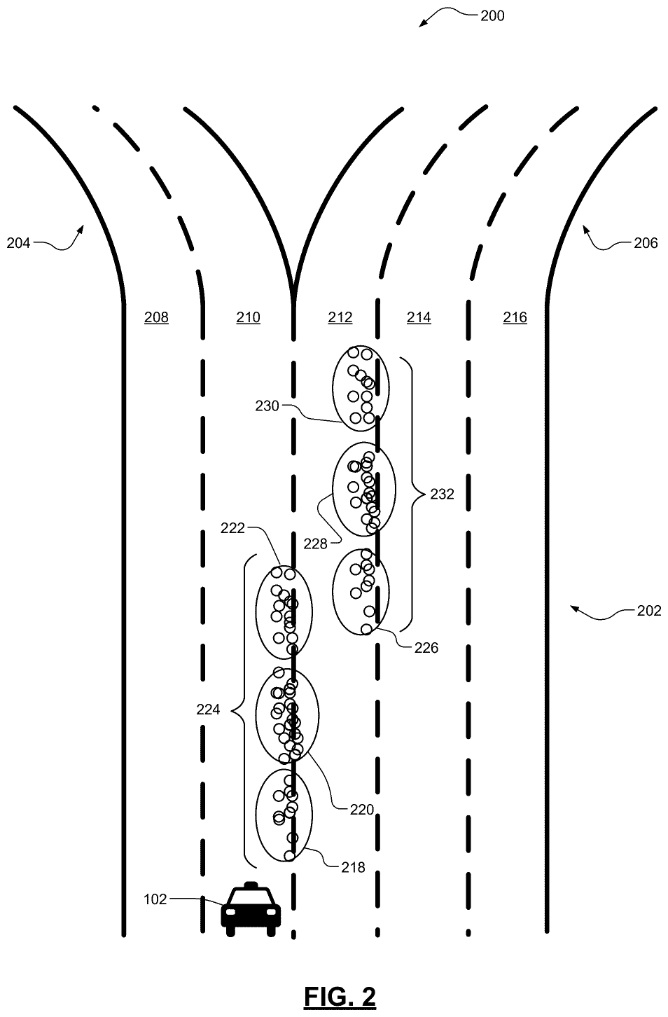

For example, FIG. 2 depicts a map 200 showing identified road segments along a road with a road event having a fixed location. Specifically, in FIG. 2, the map 200 includes a multi-lane road 202 that bifurcates into two separate roads 204, 206. More specifically, lanes 208, 210, 212, 214, 216 of the road 202 divide and form the roads 204, 206, with the lanes 208, 210 forming the road 204 and the lanes 212, 214, 216 forming the road 206. In the example of FIG. 2, the road 202 is a multi-lane highway, the road 204 is another multi-lane highway (or the same highway as the road 202), and the road 206 is a multi-lane freeway. In this example, the vehicle 102 is traveling in the lane 210 that eventually splits off to form the road 204, but needs to proceed forward with the road 206, and more preferably lane 214 of the road 206 according to, for example, instructions from a navigation system. Although the example of FIG. 2 depicts a five-lane road 202 bifurcating into one road 204 with two lanes and another road 206 with three lanes, it should be appreciated that the road 202 may include more or less lanes, split into more roads with a different number of lanes.

As shown in FIG. 2, the control module 116 may cluster data (shown by circles) in a defined region 224 relating to where vehicles providing crowdsourced data have merged into the lane 212. Then, the control module 116 identifies a road segment 218, 220, 222 associated with each cluster of data. In this example, the clusters may represent the road segments 218, 220, 222 where most of the vehicles merge to the lane 212 (from the lane 210). Then, the control module 116 may implement similar steps to merge into the lane 214. For instance, the control module 116 may cluster additional data in another defined region 232 relating to where vehicles providing crowdsourced data have merged into the lane 214 (from the lane 212), and then identify additional road segment 226, 228, 230 associated with each cluster of data. Although the example of FIG. 2 depicts three road segments, it should be appreciated that more or less road segments may be identified associated with merging into the lane 212 and/or merging into the lane 214 if desired and/or based on the clustered data, the defined region, etc.

With continued reference to FIGS. 1-2, the control module 116 then may determine reliability scores for the road segments 218, 220, 222 in the defined region 224 and the road segments 226, 228, 230 in the defined region 232. While the description below focuses on the determination of reliability scores for the road segments 218, 220, 222, similar steps may be taken to determine reliability scores for the road segments 226, 228, 230 (but with respect to data and attributes associated with the defined region 232 and the lane 212).

The reliability scores for the road segments 218, 220, 222 may be determined based on merged location data of the vehicles providing the crowdsourced data and that traveled into the defined region 224 of the road 202. As an example, the control module 116 may determine a reliability score for each road segment 218, 220, 222 based on the frequency of which each vehicle has traveled into the defined region 224 of the road 202. As such, each reliability score generally represents a level of reliability associated with the crowdsourced data.

In various embodiments, the control module 116 may determine one or multiple reliability scores for each road segment 218, 220, 222. For example, each reliability score for a road segment may be determined and specific to a different driving situation or condition, such as morning, afternoon, nighttime, bad weather, etc. In such examples, the control module 116 may generate multiple clusters based on the location data specific to each driving condition and then determine a reliability score for each road segment and driving condition. In such examples, the driving condition may be a different time of day (e.g., 7:30 AM, morning, morning rush hour, afternoon drive, evening rush hour, after dark, etc.), a different day (e.g., Monday, Friday, Sunday, weekday, weekend, etc.), a road condition (e.g., icy, wet, dry, etc.), a weather condition (e.g., foggy, raining, snowing, etc.), etc.

In some examples, the control module 116 may determine each reliability score based on the area familiarity with the roads 202, 204, 206 of the vehicles providing the crowdsourced data. For example, the control module 116 may determine familiarity scores for the vehicles in each road segment 218, 220, 222 based on the frequency of which the vehicles have traveled through the defined region 224 and then determine the reliability scores for the road segments based on the familiarity scores.

As one example, a reliability score for a road segment may be determined according to equation (9) below in which a vehicle count (V) is divided based on the area familiarity of the vehicles. In this example, the reliability score is computed by multiplying each vehicle count (V) for a different level of familiarity and a corresponding weight value (ω) and then summing the results. The vehicle counts may be obtained from the crowdsourced data.

$${R}_{S c o r e} = \sum [ {ω}_{H} {V}_{1} + {ω}_{M} {V}_{2} + {ω}_{L} {V}_{3} + {ω}_{0} {V}_{4} ] \qquad Equation ( 9 )$$

In equation (9) above, V₁ represents the number of vehicles (or a vehicle count) which pass through the interchange associated with the roads 202, 204, 206 every day (e.g., every weekday), V₂ represents the number of vehicles which pass through the interchange at least one a week, V₃ represents the number of vehicles which pass through the interchange a few times (e.g., less than once a week, etc.), and V₄ represents the number vehicles which are new to the interchange (e.g., have never passed through the interchange). Additionally, in equation (9), ω_{H} represents a high reliability/familiarity score weight, ωₘ represents a medium reliability/familiarity score weight, ω_{L} represents a low reliability/familiarity score weight, and ω₀ represents a zero reliability/familiarity score weight. In such examples, the high reliability/familiarity score weight is the largest value (e.g., most weight) whereas the low reliability/familiarity score weight is the lowest value (e.g., least weight). The corresponding weight values (ω) for each vehicle count may be defined and tuned as desired. As example only, ω_{H} may be 0.8, ωₘ may be 0.5, ω_{L} may be 0.2, and ω₀ may be zero.

In some examples, some or all of the reliability scores may be modified one or more times if desired. For example, the control module 116 may modify one or more reliability scores for each road segment 218, 220, 222 (and/or each road segment 226, 228, 230) based on a frequency of braking incidents in the road segment. In such examples, the control module 116 may identify a number of hard braking incidents in a road segment from the crowdsourced telemetry data, and then modify a reliability score accordingly. In this example, hard braking incidents may be defined as speed decreases that are greater than or equal to a defined threshold (e.g., 20 kilometers/hour/second, etc.). As one example, the control module 116 may determine a modified reliability score (R_{Score-mod}) according to equation (10) below.

$${R}_{S c ore - mod} = {R}_{S c o r e} - \sum {α}_{i} {δ}_{i} \qquad Equation ( 10 )$$

In equation (10), i represents the number of braking incidents (e.g., hard braking incidents) and alpha (∝) represents a weight based on the brake intensity, delta (δ) is a fixed value reliability score decrement per hard braking incident, and R_{Score} represents the original reliability score.

Additionally, in some embodiments, the control module 116 may modify one or more reliability scores for each road segment 218, 220, 222 (and/or each road segment 226, 228, 230) based on the total time taken to merge by all vehicles from that road segment. As one example, the control module 116 may determine a modified reliability score (R_{Score-mod2}) according to equation (11) below. In equation (11), j represents the number of vehicles merged to the lane 212 (or the lane 214) of FIG. 2 at a given instance, beta (β) is a scaling parameter, tⱼ represents a time for the vehicle in question to merge, to represents a designated time for merging, and R_{Score-mod} represents the previously modified reliability score in equation (10). In other examples, equation (11) may include R_{Score} (the original reliability score) instead of R_{Score-mod}.

$${R}_{Score - mod 2} = {R}_{S c ore - mod} - {\sum }_{j} {β}_{j} ( {t}_{j} - {t}_{0} ) \qquad Equation ( 11 )$$

In various embodiments, the control module 116 may store each of the determined reliability scores in a database. The stored reliability scores may be modified as explained above or not. In such examples, the database may include segment information relating to the road segments 218, 220, 222, 226, 228, 230 corresponding to the reliability scores, driving conditions corresponding to the reliability scores, etc. This database (or data therein) may be accessible and/or provided to the control module 104 for creating lane merging recommendations.

With continued reference to FIG. 1, the control module 104 may then select one of the road segments 218, 220, 222 with the highest reliability score and one of the road segments 226, 228, 230 with the highest reliability score for use in creating lane merging recommendations. In some examples, when the reliability scores are generated according to different driving conditions, the control module 104 may select the road segment with the highest reliability score having a driving condition that corresponds to a current driving condition associated with the vehicle 102. For instance, the control module 104 may determine the current driving condition (e.g., morning, afternoon, nighttime, bad weather, etc.) based on inputs from the sensors 110, 112, 114, inputs from other onboard sensors, and/or inputs from external sources. Then, based on the current driving condition, the control module 104 may select the road segment with the highest reliability score for that equivalent driving condition.

Then, the control module 104 may identify a portion of the selected road segment optimal for merging into the lane 212 and/or the lane 214. While the description below focuses on the selected road segment associated with merging into the lane 212, similar steps may be taken for merging into the lane 214. For example, the control module 104 may divide the selected road segment for merging into the lane 212 into multiple portions (or multiple subsegments). In such examples, the portion of the selected road segment may be identified based on, for example, a probability of having a time gap to change lanes and a difference in vehicle speeds between the adjacent lanes (e.g., the lanes 210, 212), as further explained above.

For example, at a time of interest or another driving condition, the road segment 222 of FIG. 2 may have a greater reliability score than reliability scores for the road segments 220, 218. In this example, the control module 104 selects the road segment 222 and divides that road segment into multiple portions (e.g., two or more portions). Then, for each portion, the control module 104 may determine the probability of having a time gap to change lanes and a lane merge feasibility based on the probability. For instance, and as explained above, the lane merge feasibility for each portion may be determined based on, for example, a number of vehicles, an expected headway, a vehicle speed, and speed difference with the vehicles in the adjacent lanes 210, 212.

With continued reference to FIG. 1, the vehicle system 100 may take one or more actions based on the lane change feasibilities. In some examples, the vehicle system 100 may control one or more vehicle operations of the vehicle 102 based on the identified portion of the lane most optimal for merging. For instance, the control module 104 of FIG. 1 may transmit one or more signals representative of the identified portion to the vehicle control module 108. Then, the vehicle control module 108 may control at least one operation of the vehicle 102 based on the identified portion. For example, the vehicle control module 108 may generate a control signal for controlling the vehicle 102 to merge into the lane 212 and/or the lane 214 of FIG. 2 when the vehicle 102 is in the identified portion, as explained above.

Additionally, the vehicle system 100 may display the identified portion highlighted to indicate lane recommendations of which lane the vehicle 102 should be in and where to merge into that lane for the approaching road event (e.g., an interchange, etc.). In other words, the lane recommendations are provided to ensure the vehicle 102 is positioned in an appropriate lane at an appropriate time (e.g., the “right lane at the right time”). In such examples, the control module 104 may transmit one or more signals representative of the identified portion, and/or, if applicable, the selected road segment, the portions thereof, their modified lane change feasibilities, etc. to the display module 106. The display module 106 may then output a visual representation of the identified portion highlighted and/or, if applicable, the selected road segment with some or all of the portions highlighted for driver viewing. In various embodiments, the visual representation may include only the identified portion highlighted. In other examples, the visual representation may include other portions (including the identified portion) highlighted in a different manner (e.g., a different color).

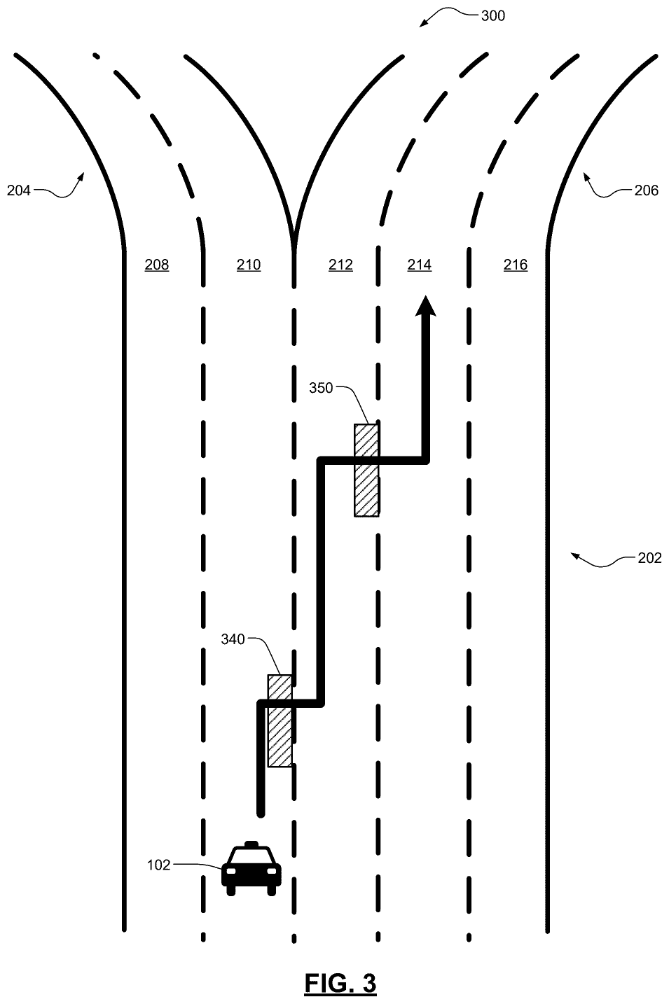

For example, FIG. 3 depicts a map 300 including a visual representation of identified portions highlighted for driver viewing. As shown, the map 300 includes the road 202 which bifurcates into the road 204 with the lanes 208, 210 and the road 206 with the lanes 212, 214, 216, as explained above. In this example, highlighted portions 340, 350 are shown in lanes 210, 212 to indicate optimal lane merge opportunities for the vehicle 102 to ensure the vehicle 102 is positioned in the lane 214 of the road 206 at an appropriate time for the upcoming interchange (e.g., bifurcation).

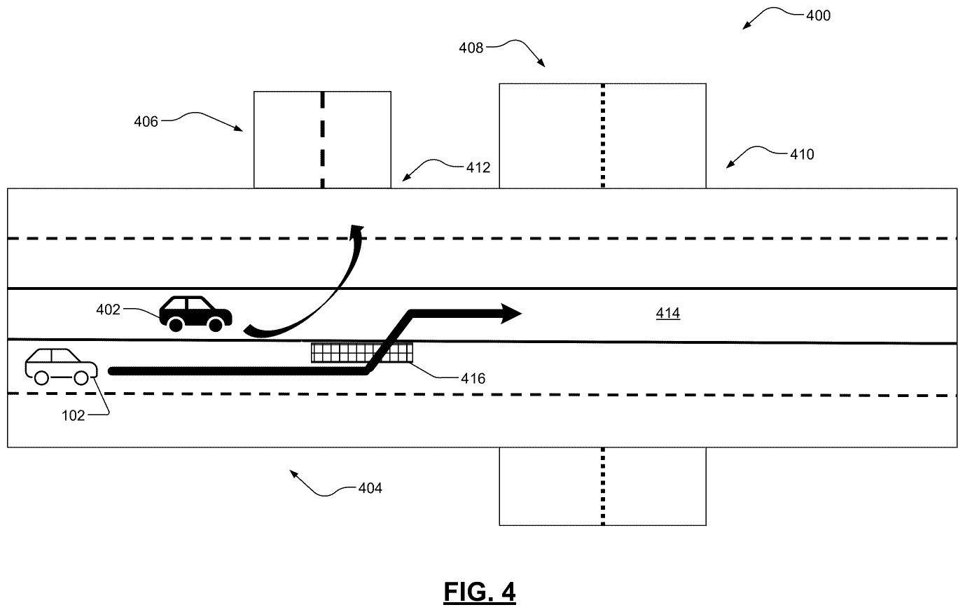

In other examples, the interchange may be another suitable type of transition, such as turning onto a new road at a crossroad intersection. For example, FIG. 4 depicts a map 400 including a visual representation of an identified portion highlighted for driver viewing. As shown, the map 400 includes roads 404, 406, 408. Here, the roads 404, 408 form an intersection 410 in which traffic is allowed to turn right or left from the road 404 to the road 408, or continue straight on the road 404. In this example, the vehicle 102 of FIG. 1 is traveling along the road 404 and needs to turn onto the road 408 according to, for example, instructions from a navigation system. Additionally, the roads 404, 406 form another intersection 412 just before the intersection 410 with respect to the vehicle 102. In this example, a vehicle 402 is turning on the road 406 in a turn lane 414 of the road 404 and a highlighted portion 416 is shown in the turn lane 414 just beyond the vehicle 102 to indicate an optimal lane merge opportunity for the vehicle 102 to ensure the vehicle 102 is positioned in the lane 414 at an appropriate time for the upcoming intersection 410.

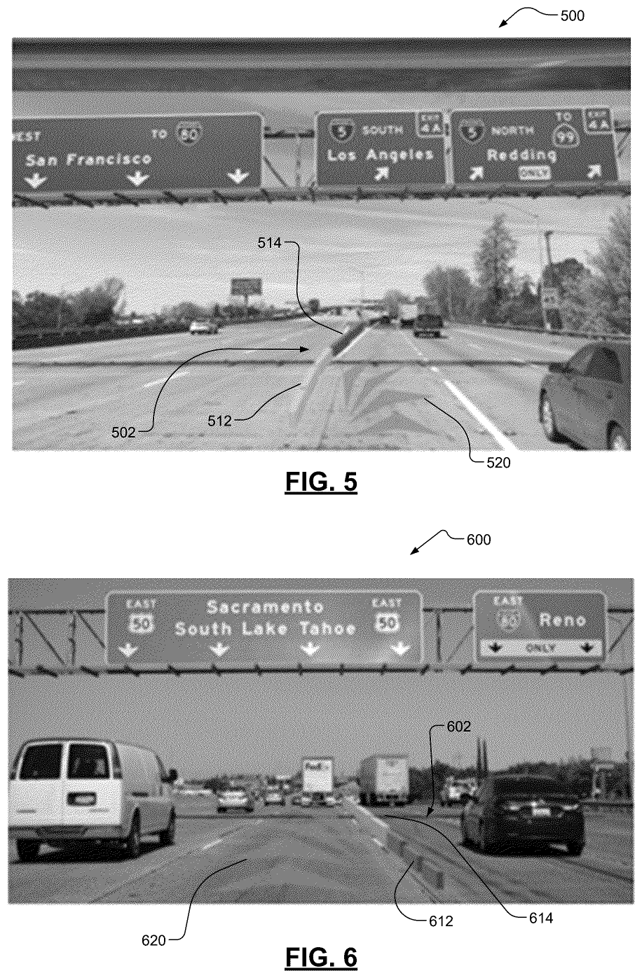

FIGS. 5-8 depict other examples of visual representations 500, 600, 700, 800 that may be provided by the display module 106, such as via a heads-up display in the vehicle 102. For example, in FIG. 5, the visual representation 500 includes a selected road segment 502 with portions 512, 514. In this example, the portion 512 is highlighted green indicating the most optimal lane merge opportunity for the vehicle 102 and the portion 514 is highlighted red indicating less optimal lane merge opportunity for the vehicle 102. Additionally, in FIG. 5, the visual representation 500 includes arrows 520 directing the driver of the vehicle 102 to merge in in the portion 512.

In FIG. 6, the visual representation 600 includes a selected road segment 602 with portions 612, 614. In this example, the portion 614 is highlighted green indicating the most optimal lane merge opportunity for the vehicle 102 and the portion 612 is highlighted red indicating less optimal lane merge opportunity for the vehicle 102. Like in FIG. 5, the visual representation 600 of FIG. 6 includes arrows 620 directing the driver of the vehicle 102 to merge in the portion 614.

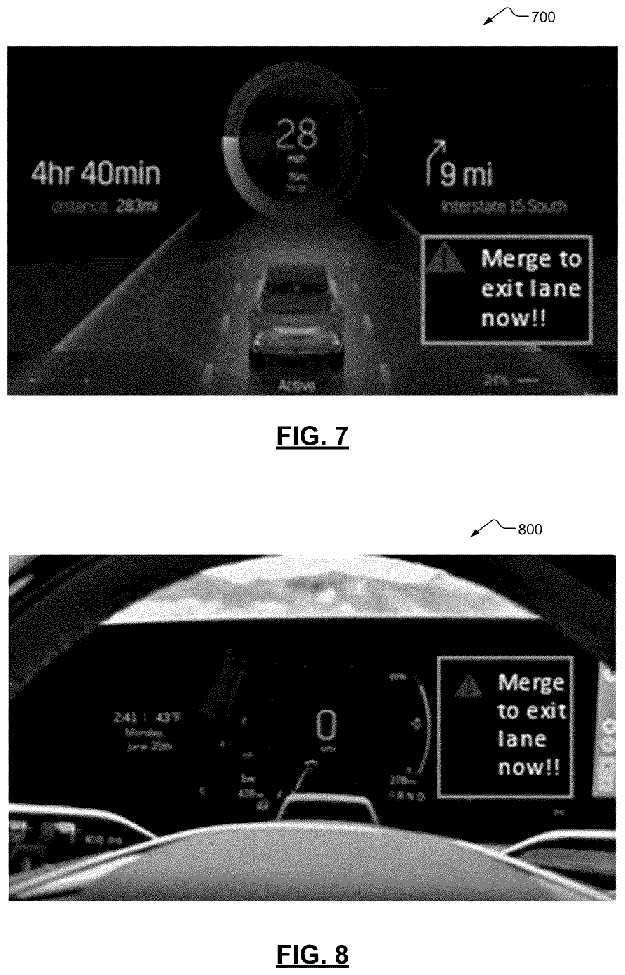

In FIGS. 7-8, the visual representation 700, 800 provide examples of notifications instructing a driver to “merge to exit lane now.”

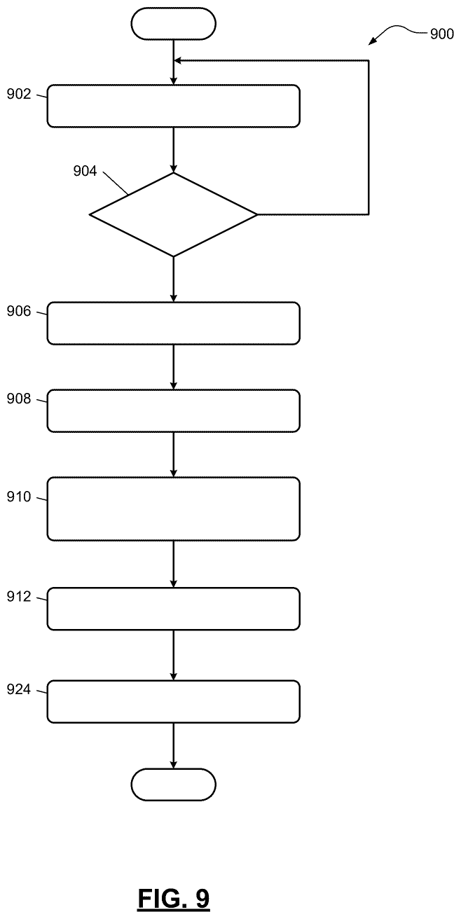

FIGS. 9-12 illustrate example control processes 900, 1000, 1100, 1200, 1300 employable by the vehicle system 100 of FIG. 1. Although the example control processes 900, 1000, 1100, 1200, 1300 are described in relation to the vehicle system 100 of FIG. 1 including the control module 104, the display module 106, the vehicle control module 108, and/or the control module 116, any one of the control processes 900, 1000, 1100, 1200, 1300 may be employable by another suitable system and/or other suitable modules if desired.

The control process 900 of FIG. 9 is implemented for vehicle lane recommendations for a vehicle traveling on a road. As shown in FIG. 9, the control process 900 begins at 902 by receiving vehicle data. For example, and as explained above, the control module 116 of FIG. 1 may receive crowdsourced telemetry data from vehicles, including possibly the vehicle 102 traveling along the road. Such data may provide real-time traffic conditions. Additionally, the control module 116 may receive the current driving route for the vehicle 102 and any possible changes to the driving route, as explained above. The control process 900 then proceeds to 904.

At 904, control determines whether the vehicle 102 is approaching a road event, such as an interchange, traffic congestion, an accident, a road condition, maneuvers in navigation instruction, etc. This may be determined based on, for example, the crowdsourced telemetry data, instructions from a navigation system, etc. For example, the control module 104 of FIG. 1 may make this determination based on inputs from the navigation system (e.g., a mapping system) tracking and providing instructions about upcoming maneuvers to reach a desired location. If yes at 904, the control process 900 proceeds to 906. Otherwise, if no at 904, the control process 900 returns to 902.

At 906, the control module 116 identifies a lane that the vehicle 102 should be in to provide a smooth navigation (e.g., an optimal lane). In various embodiments, the control module 116 may identify this lane based on a current driving route for the vehicle, changes to the current driving route, and real-time traffic conditions. For example, the control module 116 may ascertain real-time traffic conditions based on the received crowdsourced data of 902. The control process 900 then proceeds to 908.

At 908, the control module 104 determines a lane merge feasibility for merging into the identified lane of 906. For example, and as explained above, the control module 104 may implement the equation (5) above to determine a lane merge feasibility for the identified lane. The control process 900 then proceeds to 910.

At 910, the control module 104 determines a modified lane merge feasibility based on lane speed data. For example, and as explained above, the control module 104 may implement the equation (6) above to determine a modified lane merge feasibility based on the lane speeds before and after the road event and the lane merge feasibility of 908. The control process 900 then proceeds to 912, where the control module 104 identifies a portion of the lane optimal for merging, as explained above. The control process 900 then proceeds to 914.

At 914, the control module 104 controls at least one vehicle action based on the modified lane merge feasibility. Fo example, and as explained above, the control module 104 may transmit one or more signals to the display module 106. In turn, the display module 106 may output a visual representation of the portion of the lane highlighted for driver viewing. Additionally and/or alternatively, the control module 104 may control module 104 may transmit one or more signals representative of the identified portion to the vehicle control module 108. Then, the vehicle control module 108 may control at least one operation of the vehicle 102 based on the identified portion.

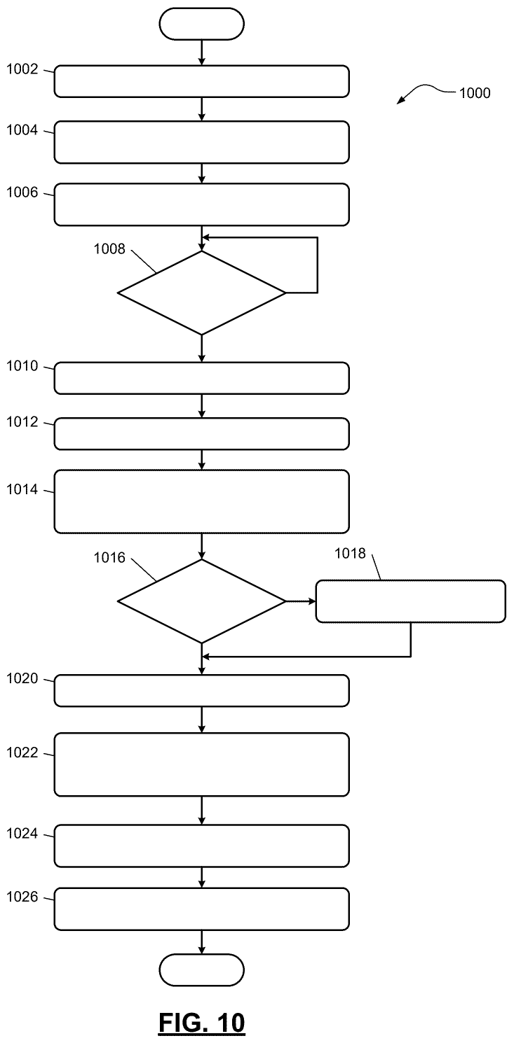

The control process 1000 of FIG. 10 is implemented for providing visual representations of vehicle lane recommendations approaching an interchange or another fixed location road event. As shown in FIG. 10, the control process 1000 begins at 1002 by identifying road segments in a defined region. In such examples, the control module 116 of FIG. 1 may identify such road segments based on based on crowdsourced data. For example, and as explained above, the control module 116 may cluster location data (from the crowdsourced data) in the defined region relating to where vehicles have merged and then identify road segments associated with each cluster. The control process 1000 then proceeds to 1004.

At 1004, the control module 116 determines one or more reliability scores for each road segment for different driving conditions. For example, and as explained above, the control module 116 may determine the reliability score(s) based on the frequency of which the vehicles have traveled the interchange. In such examples, the control module 116 may determine familiarity scores for the vehicles and then determine the reliability scores for the road segments based on the familiarity scores, as explained above. The control process 1000 then proceeds to 1006.

At 1006, the control module 116 optionally modifies the reliability scores based on one or more conditions. For example, and as explained above, the control module 116 may modify the reliability scores based on the frequency of braking incidents, the total time taken to merge by all vehicles, etc. The control process 1000 then proceeds to 1008.

At 1008, control determines whether the vehicle 102 is approaching the interchange with the intent to turn, change roads, etc. at the interchange according to, for example, instructions from a navigation system. For example, the control module 104 of FIG. 1 may make this determination based on inputs from the navigation system (e.g., a mapping system) tracking and providing instructions about upcoming maneuvers to reach a desired location. If yes at 1008, the control process 1000 proceeds to 1010. Otherwise, if no at 1008, the control process 1000 returns to 1008. In other examples, the control process 1000 may return to another suitable step (e.g., 1002, etc.) if desired.

At 1010, the control module 116 may identified (or determined) a lane that the vehicle 102 should be in to provide a smooth navigation (e.g., an optimal lane) as explained above. The control process 1000 then proceeds to 1012.

At 1012, the control module 104 determines a current driving condition associated with the vehicle 102. For example, and as explained above, the control module 104 may determine the current driving condition based on inputs from the sensors 110, 112, 114, inputs from other onboard sensors, and/or inputs from external sources. The control process 1000 then proceeds to 1014, where the control module 104 selects a road segment of the identified road segments with the highest reliability score that corresponds to the current driving condition. The control process 1000 then proceeds to 1016.

At 1016, the control module 104 determines whether a time gap requirement to change lanes needs to be modified. For example, and as explained above, a time gap requirement to change lanes may be modified based on driver characteristics, road conditions, etc. In such examples, a required vehicle gap distance may be modified based on a cognitive status of the driver, a condition of the road, etc., which in turn modified the time gap requirement, as explained above. This determination as to whether a time gap requirement to change lanes needs to be modified may be ascertained from user input, driving behavior obtained from onboard sensors, environmental conditions (e.g., road conditions, weather conditions, etc.) obtained from onboard sensors and/or external sources, etc. If no at 1016, the control process 1000 proceeds to 1020. If yes at 1016, the control process 1000 proceeds to 1018 where the control module 104 modifies the time gap requirement based on one or more conditions, as explained above. The control process 1000 then proceeds to 1020.

At 1020, the control module 104 determines a lane merge feasibility for the selected road segment (or individual portions therein). For example, the control module 104 may implement the equation (5) above to determine a lane merge feasibility for the selected road segment (or individual portions therein). The control process 1000 then proceeds to 1022.

At 1022, the control module 104 determines a modified lane merge feasibility for the selected road segment (or individual portions therein) based on interchange environment information. For example, and as explained above, the control module 104 may implement the equation (6) above to determine a modified lane merge feasibility based on the lane speeds before and after the interchange and the lane merge feasibility of 1020. The control process 1000 then proceeds to 1024, where the control module 104 identifies a portion of the selected road segment optimal for merging, as explained above. The control process 1000 then proceeds to 1026.

At 1026, the display module 106 outputs a visual representation of the selected road segment with some or all of the portions highlighted (including the identified portion) for driver viewing, as explained above. The control process 1000 then ends as shown in FIG. 10. Alternatively, the control process 1000 may return to another step, such as 1008 if desired.

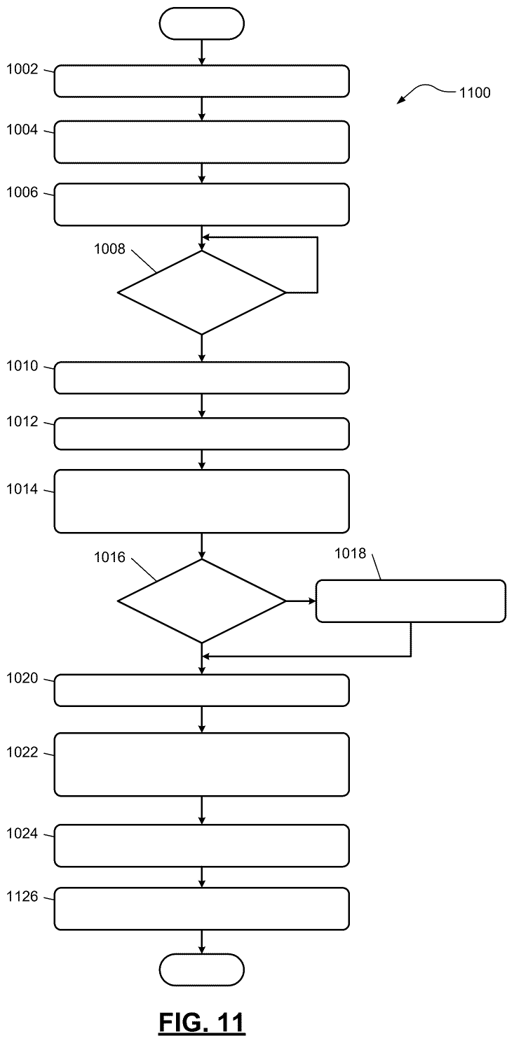

The control process 1100 of FIG. 11 is implemented for controlling a vehicle approaching an interchange or another fixed location road event based on vehicle merge lane recommendations. In FIG. 11, the control process 1100 is similar to the control process 1000 of FIG. 10 but includes an alternative step. For example, and as shown in FIG. 11, the control process 1100 includes 1002, 1004, 1006, 1008, 1010, 1012, 1014, 1016, 1018, 1020, 1022, 1024 of FIG. 10 as explained above, and then proceeds to 1126. At 1126, the vehicle control module 108 controls at least one operation of the vehicle 102 based on the identified portion (from 1024). For example, and as explained above, the vehicle control module 108 may generate a control signal for controlling the vehicle 102 to merge into the lane 212 of FIG. 2 and/or the lane 214 when the vehicle 102 is in the identified portion of the selected road segment. The control process 1100 then ends as shown in FIG. 11.

Alternatively, the control process 1100 may return to another step, such as 1008 if desired.

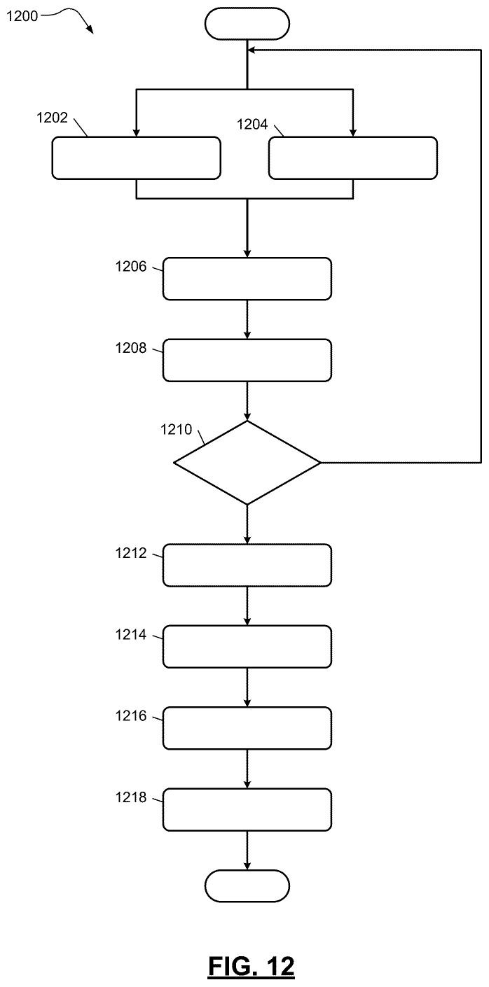

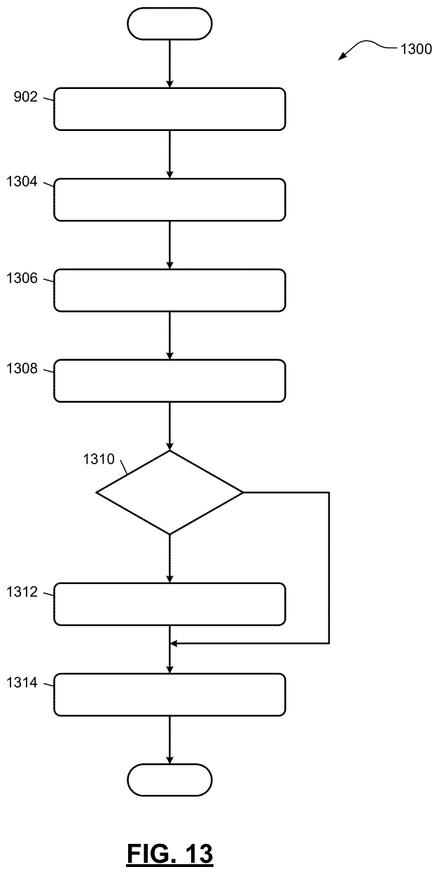

The control processes 1200, 1300 of FIGS. 12 and 13 are implemented for determining familiarity scores and reliability scores, respectively. In such examples, the familiarity scores and reliability scores may be utilized when locations are fixed, such as known road bifurcations or other suitable types of interchanges, as explained above. In FIG. 12, the control process 1200 begins at 1202, 1204. At 1202, the control module 116 receives crowdsourced telemetry data (as explained above). At 1204, the control module 116 receives road level map data (e.g., an open street map (OSM), etc.). Then, the control process 1200 proceeds to 1206. At 1206, the control module 116 implements a map matching process to coordinate the crowdsourced telemetry data and the road level map data. The control process 1200 then proceeds to 1208.

At 1208, the control module 116 receives lane level map data. For example, the lane level map data may include detailed information (e.g., lane level details), such as lane boundaries, associated timestamps, etc. The control process 1200 then proceeds to 12100, where the control module 116 determines if a lane change/merge is detected. In such examples, this determination may be made based on the coordinated crowdsourced telemetry data and the road level map data, and the lane level map data. If yes at 1210, the control process 1200 proceeds to 1212, 1214. If no at 1210, the control process 1200 returns to 1202, 1204.

At 1212, the control module 116 aggregates location data from the crowdsourced telemetry data. Then, at 1214, the control module 116 aggregates vehicle IDs associated with the location data. For example, the control module 116 may aggregate particular location data relative to a defined region at the lane change/merge location and the vehicle IDs for the vehicles providing such location data. The control process 1200 then proceeds to 1216.

At 1216, the control module 116 determines a cumulative frequency for the vehicles based on the vehicle IDs. For example, the control module 116 may identify each vehicle (based on its vehicle ID) that has passed through a particular interchange and separate the vehicle occurrences based on the level of area familiarity of the vehicles. In such examples, the vehicle occurrences for different levels of familiarity may be aggregated into multiple, distinct vehicle counts. In this example, each vehicle count may represent a number of vehicles which pass through the interchange per a defined time occurrence (e.g., daily, weekly, etc.). The control process 1200 then proceeds to 1218.

At 1218, the control module 116 determines familiarity scores for the vehicles in each road segment based on the cumulative frequency of 1216 and weighted values. For example, and as explained above, the control module 116 may determine familiarity scores by multiplying each vehicle count for a different level of familiarity and a corresponding weight value. The control process 1200 then ends as shown in FIG. 12.

In FIG. 13, the control process 1300 begins at 1002 of FIG. 10, where the control module 116 identifies road segments in a defined region for merging, such as from the lane 210 to the lane 212 of FIG. 2. The control process 1300 then proceeds to 1304.

At 1304, the control module 116 determines familiarity scores for vehicles in the road segments. For example, the control module 116 may implement the control process 1200 of FIG. 12 for determining the familiarity scores. The control process 1300 then proceeds to 1306, where the control module 116 determines a reliability score for each road segment. For example, and as explained above, the control module 116 may determine such reliability scores according to equation (1). The control process 1300 then proceeds to 1308, the control module 116 may optionally determine reliability scores for each road segment for different driving conditions (as explained above). The control process 1300 then proceeds to 1310.

At 1310, the control module 116 determines whether modifications to the reliability scores are desired. This may be determined based on user input, detected driving characteristics of other vehicles, etc. If yes at 1310, the control process 1300 proceeds to 1312. If no at 1310, the control process 1300 proceeds to 1314.

At 1312, the control module 116 modifies the reliability scores based on one or more conditions. For example, and as explained above, the control module 116 may modify the reliability scores based on the frequency of braking incidents, the total time taken to merge by all vehicles, etc. The control process 1300 then proceeds to 1314.

At 1314, the control module 116 stores information for each road segment in a database. For example, and as explained above, the control module 116 may store the determined reliability scores (whether modified or not) for the different road segments along with driving conditions corresponding to the reliability scores. This database (or data therein) may be accessible and/or provided to the control module 104 for creating lane merging recommendations, as explained above.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for providing vehicle lane recommendations for a vehicle traveling on a road, the vehicle system:
a control module configured to:
identify a lane that the vehicle should be in to provide a smooth navigation based on a current driving route for the vehicle, changes to the current driving route, and real-time traffic conditions;
determine a lane merge feasibility based on an expected headway value and a time gap to merge into the identified lane;
determine a modified lane merge feasibility based on the lane merge feasibility and lane speed data; and
identify a portion of the identified lane to merge based on the modified lane merge feasibility; and
a display module in communication with the control module, the display module configured to output a visual representation of the identified portion highlighted to indicate recommendations of which lane the vehicle should be in and where to merge into that lane.

2. The vehicle system of claim 1, further comprising a vehicle control module in communication with the control module, the vehicle control module configured to control at least one operation of the vehicle based on the identified portion of the identified lane.

3. The vehicle system of claim 1, wherein the control module is configured to modify the time gap to merge into the identified lane based on a cognitive status of a driver of the vehicle.

4. The vehicle system of claim 1, wherein the control module is configured to modify the time gap to merge into the identified lane based on a condition of the road.

5. The vehicle system of claim 1, wherein:
the vehicle lane recommendations for the vehicle are for a bifurcation of the road in which the road splits into two or more separate roads;
the lane speed data includes an average lane speed before the bifurcation and an average lane speed after the bifurcation; and
the control module is configured to determine the modified lane merge feasibility based on the lane merge feasibility, the average lane speed before the bifurcation, and the average lane speed after the bifurcation.

6. The vehicle system of claim 5, wherein:
the control module is configured to:
determine one or more reliability scores for each road segment of a plurality of road segments of the road based on a frequency of which each vehicle of a plurality of vehicles has traveled on the road, wherein each reliability score for each road segment is specific to a different driving condition; and
select a road segment of the road segments with the highest reliability score having the driving condition that corresponds to a current driving condition associated with the vehicle; and
the identified portion is a portion of the selected road segment to merge into the identified lane based on the modified lane merge feasibility.

7. The vehicle system of claim 6, wherein the control module is configured to:
determine familiarity scores for the plurality of vehicles in each road segment based on the frequency of which the plurality of vehicles have traveled through the bifurcation; and
determine the one or more reliability scores for each road segment based on the familiarity scores for that road segment.

8. The vehicle system of claim 6, wherein the driving condition includes at least one of a different time of day, a different road condition, and a different weather condition.

9. The vehicle system of claim 6, wherein the control module is configured to modify the one or more reliability scores for each road segment based on a frequency of braking incidents for the plurality of vehicles in the road segments of the road.

10. A vehicle system for providing vehicle lane recommendations for a vehicle traveling on a road, the vehicle system:
a control module configured to:
identify a lane that the vehicle should be in to provide a smooth navigation based on a current driving route for the vehicle, changes to the current driving route, and real-time traffic conditions;
determine a lane merge feasibility based on an expected headway value and a time gap to merge into the identified lane;
determine a modified lane merge feasibility based on the lane merge feasibility and lane speed data; and
identify a portion of the identified lane to merge based on the modified lane merge feasibility; and
a vehicle control module in communication with the control module, the vehicle control module configured to control the vehicle to merge in the identified portion.

11. The vehicle system of claim 10, wherein the control module is configured to modify the time gap to merge into the identified lane based on a cognitive status of a driver of the vehicle.

12. The vehicle system of claim 10, wherein the control module is configured to modify the time gap to merge into the identified lane based on a condition of the road.

13. The vehicle system of claim 10, wherein:
the vehicle lane recommendations for the vehicle are for a bifurcation of the road in which the road splits into two or more separate roads;
the lane speed data includes an average lane speed before the bifurcation and an average lane speed after the bifurcation; and
the control module is configured to determine the modified lane merge feasibility based on the lane merge feasibility, the average lane speed before the bifurcation, and the average lane speed after the bifurcation.

14. The vehicle system of claim 13, wherein:
the control module is configured to:
determine one or more reliability scores for each road segment of a plurality of road segments of the road based on a frequency of which each vehicle of a plurality of vehicles has traveled on the road, wherein each reliability score for each road segment is specific to a different driving condition; and
select a road segment of the road segments with the highest reliability score having the driving condition that corresponds to a current driving condition associated with the vehicle; and
the identified portion is a portion of the selected road segment to merge into the identified lane based on the modified lane merge feasibility.

15. The vehicle system of claim 14, wherein the control module is configured to:
determine familiarity scores for the plurality of vehicles in each road segment based on the frequency of which the plurality of vehicles have traveled through the bifurcation; and
determine the one or more reliability scores for each road segment based on the familiarity scores for that road segment.

16. The vehicle system of claim 14, wherein the driving condition includes at least one of a different time of day, a different road condition, and a different weather condition.

17. The vehicle system of claim 14, wherein the control module is configured to modify the one or more reliability scores for each road segment based on a frequency of braking incidents for the plurality of vehicles in the road segments of the road.

18. A vehicle control method for providing vehicle lane recommendations for a vehicle traveling on a road, the vehicle control method comprising:
identifying a lane that the vehicle should be in to provide a smooth navigation based on a current driving route for the vehicle, changes to the current driving route, and real-time traffic conditions;
determining a lane merge feasibility based on an expected headway value and a time gap to merge into the identified lane;
determining a modified lane merge feasibility based on the lane merge feasibility and lane speed data;
identifying a portion of the identified lane to merge based on the modified lane merge feasibility; and
outputting a visual representation of the identified portion highlighted to indicate recommendations of which lane the vehicle should be in and where to merge into that lane.

19. The vehicle control method of claim 18, further comprising controlling the vehicle to merge in the identified portion.

20. The vehicle control method of claim 18, further comprising modifying the time gap to merge into the identified lane based on at least one of a cognitive status of a driver of the vehicle and a condition of the road.
